(19) United States
(12) Patent Application Publication
(10) Pub. No.: US 2006/0081528 A1
(43) Pub. Date: Apr. 20, 2006

(54) Air filter

(75) Inventors: Reinhard Oelpke, Harthausen (DE); Andreas Pelz, Markgroeningen (DE); Johannes Lampert, Remseck (DE); Franziska Schulz, Waldsee (DE); Torsten Hotop, Freiberg (DE)

Correspondence Address: CROWELL & MORING LLP;INTELLECTUAL PROPERTY GROUP, P.O. BOX 14300, WASHINGTON, DC, 20044-4300, US

(73) Assignee: MANN & HUMMEL GmgH, Ludwigsburg (DE)

(21) Appl. No.: 11/247,201

(22) Filed: Oct. 12, 2005

(30) Foreign Application Priority Data
Oct. 13, 2004 (DE) 10 2004 050 018.5

(51) Int. Cl. B01D 29/07

(52) U.S. Cl. 210/493.1; 210/489; 210/497.1; 55/521

(57) ABSTRACT

A filter assembly for fluids including a filter element configured for axial through flow that has alternately sealed filter channels for axial through flow and a centrally disposed support member, which in conjunction with a mating part ensures that the filter element can be handled for servicing purposes. The mating part is preferably constructed as a retaining grid, which prevents damage to the axial end surface of the filter element.

### BACKGROUND OF THE INVENTION

The present invention relates to an air filter element with an axial end face inlet. The invention further relates to a mating part which fits the filter element and includes a member that engages in an opening in a filter element support body and to a filter system assembly comprising such a filter and mating part.

Filter elements configured for axial through-flow are used in many applications where a gas or liquid must be filtered. To this end, these elements are inserted in various types of housing and when used as specified must be replaced or cleaned after reaching a certain loading or after predefined service intervals. The ability to manipulate or handle the filter element is of decisive importance because a filter element that is difficult to handle may not be replaced or cleaned at all or the element or system may be damaged in an attempt to manipulate it with tools that are not designed for the purpose.

European patent no. EP 1,169,109 discloses a filter element having axial through flow with an inlet face and an oppositely disposed outlet face, with no deflection of the gas stream and having a handle that extends axially from the first end face and is firmly connected to the filter element—preferably to the inner core member of the filter element. This handle extends far enough from the end face of the filter element to enable problem-free manual handling without a tool. In many installations, however, it is disadvantageous if the filter element has a handle member extending axially beyond the end face, because this takes space away from other functional elements. Filter elements of this type are also difficult to stack during storage, and a handle fixedly connected with the core is a disadvantage in the production of the filter element because the handle must be clamped in order to wind the filter layers.

### SUMMARY OF THE INVENTION

It is therefore an object of the present invention to provide an improved axial flow filter element and filter assembly.

Another object of the invention is to provide a filter element which can be easily handled and yet does not take up excessive space.

A further object of the invention is to provide a filter element with axial through flow that is simple and cost effective to produce, takes up no additional space when installed and can be adapted to various systems.

These and other objects have been achieved in accordance with the present invention by providing a filter element for end face inflow of a fluid stream, the filter element comprising at least one flat layer and at least one folded layer of flow-through filter media, wherein the at least one flat layer alternates with the at least one folded layer such that channels with an open cross section are formed, wherein a first group of the channels are tightly sealed at one end and a second group of the channels are tightly sealed at an opposite end such that the fluid to be filtered, as it flows through the filter element from an inlet side which is formed by an end face of the filter element to an outlet side which is formed by the opposite end face of the filter element, must pass through one of the layers which are provided to filter the fluid; a seal for sealing the inlet side of the filter from the discharge side of the filter element in a housing section, and at least one support member arranged in the center of the filter element surrounded by the channels, the support member extending axially substantially up to at least one end face of the filter element, in which each channel of the first group of channels which is spaced from the periphery of the filter element is surrounded on each side by channels of the second group, so that the fluid to be filtered can flow through the full area of the channels of the first group except for the folded edges of the channels, and in which the support member is provided on a surface proximate the at least one axial end face of the filter element with at least one opening for receiving a projecting portion of corresponding mating part so that the filter element may be handled via the mating part.

In accordance with a further aspect of the invention, the objects are achieved by providing a mating part for a filter element as described above in which the mating part comprises at least one projecting portion configured to correspond to the at least one opening in the support member such that the mating part can be releasably coupled to the support member in the interior of the opening.

In an additional aspect of the invention, the objects are achieved by providing a filter assembly comprising a filter element and a mating part as described above in which the filter element is disposed in a first housing section; a radially circumferential seal of the filter element in the region of the first end face of the filter element is seated against a correspondingly configured housing seat of the first housing section such that a seal is created between the inlet side and the discharge side of the filter element; the mating part is a second housing section having at least one projecting portion clipped into the at least one opening of the support member of the filter element; the second housing section comprises a fluid-permeable retaining grid having an outer contour configured to correspond to the end face seating surface of the circumferential seal, and latching members are arranged on the outer contour of the second housing section for releasably attaching the second housing section to the first housing section with the circumferential seal of the filter element clamped therebetween, so that upon release of the housing sections from each other, the filter element can be handled via the second housing section.

The filter element according to the invention for axial end face inflow of a fluid stream has a filter medium with axial through flow, a seal on the exterior of the filter medium for sealing the inlet side from the discharge side of the filter element, and at least one support member arranged in the center of the filter element. The filter medium comprises alternately arranged flat and folded filter layers, so that the flat layer alternates with the folded layer in such a way that channels with an open, particularly a triangular, cross-section are formed. The resulting channels are alternately sealed at the end face, such that the fluid to be filtered, as it flows through the filter element from an inlet side, formed by one axial end face of the filter element, to an outlet side, formed by the other axial end face of the filter element, must pass through one of these layers that are provided for filtering the fluid. In this embodiment, the support member is arranged in the center of the filter medium and therefore surrounded by the channels, such that it extends axially substantially up to at least a first end face of the filter element.

The layers of the filter medium are preferably made of filter paper, but may also be made, for example, of a synthetic web. In the latter case the folded layer would have to be supported by impregnating the synthetic web. The filter element may have an angular, round, elliptical or oval cross section, but is preferably round at the outer edges and straight between the outer edges to form an oval. The support member arranged in the center of the filter element is preferably injection molded, but may also be made of a material other than plastic and produced by another production process. The alternating sealing of the flow channels makes it possible, by an appropriate arrangement, to achieve flow through the entire area of the filter medium surrounding the first or inlet-side channels to reach the second or outlet-side channels. Only the outermost channels are an exception.

According to the invention, the support member extends axially at least to the first axial end face of the filter element, but preferably both end faces of the support member extend up to the corresponding axial end faces of the filter medium. However, all possible differences in length between the axial length of the support member and the axial length of the filter medium are also feasible, as long as one end face of the support member extends up to the first axial end face of the filter medium. This end face of the support member has at least one end face opening adapted to receive a projecting portion of corresponding mating part to facilitate handling of the filter element. That is to say, the support member and the filter medium form a flat end face termination of the filter element at the first axial end face.

By using this mating part with a projecting portion received in an end face opening of the support member for handling the filter element, the filter element can now be removed from the housing for servicing or replacement, or reinserted into the housing, via a mating part that engages with this opening. The flat end face termination of the filter element has substantial advantages with regard to the use of space. Another advantage resides in the handling of the filter element itself, since the absence of protruding parts makes transport and storage easier and there is no risk of breakage of protruding parts during transport or handling.

In accordance with one advantageous embodiment of the invention, the at least one flat layer and the at least one folded layer are alternately wound around the support member. The support member has a step that extends axially along the height of the support member and represents a stop edge for the first winding layer. By introducing this axially extending step in the support member, it is possible to define the winding of the filter medium exactly. For example, a bead of adhesive may be applied in the vicinity of this step, to which the first winding layer is then glued so that the start of the winding layer adjoins the axially extending step. The height of the axially extending step is preferably matched to the height of the first winding layer, so that after the first full winding layer has been applied to the support member, subsequent layers encounter no step.

Since the width of the support member, i.e., the distance between the two end faces, is preferably the same as the width of the winding layers, another advantage of the embodiment of the support member becomes evident, namely that the support member can be clamped exactly into a device, such that, after the beginning of the first winding layer has been glued down, the device rotates the support member to wind the additional layers onto the support member. Since the width of the support member and that of the winding layer are identical, it is particularly easy to guide the winding layers so that they form a flat axial end face termination.

It is advantageous to arrange the axially extending step substantially in the center of the oblong support member and to dispose respective openings for facilitating handling of the filter element in each of the outer regions of the first end face of the filter element. Because of the spatial separation of the axially extending step from the end face openings of the support member, even an excess deposit of glue or adhesive causes no problems, for example by sealing up the openings of the support member.

With regard to the technique of original production, it is furthermore advantageous if a groove is provided on the support member in the region of at least one opening, parallel to the end face, along the outer surface of the support member. If the support member is made of synthetic resin material, material accumulations along the course of wall thicknesses should be avoided. Such material accumulations cause stresses and possibly warping of the molded part during cooling after the injection molding process.

Because of the stop edge or step provided in the support member for the winding layers, the two outer end regions of the support member have different thicknesses. Since the two openings formed in the support member to facilitate handling of the filter element preferably have the same size and are mutually aligned in their position, a material accumulation in the wall thickness of the opening occurs on the thicker side of the support member. Forming a groove that extends parallel to the end face in the region of this wall eliminates the material accumulation from the outside, while circumferential stop edges for the winding of the filter medium are nevertheless preserved.

In accordance with another advantageous embodiment of the invention, at least one opening of the support member has an axial stop for the mating part. This axial stop can consist of an edge protruding inwardly into the opening or a tapering of the diameter of the opening toward the interior of the support member. The axial stop affords an advantage in the handling of the filter element via the mating part, because it enables an axial pressure to be applied in the direction of the filter element via the mating part in order to bring the filter element into its mounting position.

The mating part required to handle the filter element has a portion configured to correspond to the opening in the support member, such that the mating part can be releasably coupled to the support member in the interior of the opening of the support member to facilitate handling of the filter element. A portion of the mating part engages with the support member and can releasably couple to the filter element, e.g., through a suitable latching connection. The resulting coupling makes it possible to use the mating part to remove the filter element from, or to insert it into, the mounting location. The capability of releasing the mating part preferably requires no tool, i.e., the mating part and the filter element can be non-destructively decoupled by simple manipulation.

In accordance with one embodiment of the mating part, the portion of the mating part configured to correspond to the opening in the support member has a guiding and centering part and a coupling part. Initially, the portion of the mating part with the guiding and centering part engages with the opening of the support member of the filter element and thereby aligns the filter element and the mating part relative to each other. This ensures that the sensitive end face media surface of the filter element is not damaged as the filter element and the mating part are joined. After the two parts have been centered relative to each other, the coupling element of the mating part engages the corresponding coupling member of the support member and couples itself to the support member in a releasable manner. This can be a clip connection, for example, such that, in the opening in the support member, in the further course, windows are disposed in the support member with which a flexibly attached clip projection of the mating part can engage. This coupling can be simply and easily released by pressing together the flexible attachment.

The mating part is preferably a housing section, particularly a retaining grid, such that the filter element can be handled via the housing section. It is possible, for example, for the housing section to have an air inlet for end face inflow into the filter element and to be connected to an additional housing section into which the filter element is inserted, again by a releasable coupling. Thus, when the housing section is released, the housing section can be removed together with the filter element, and the filter element and the housing section can then be decoupled from each other. In the preferred embodiment, the housing section is a retaining grid, which on the one hand minimizes the pressure loss on the inlet side of the filter element and on the other hand protects the filter medium from damage, such that the air flows directly from the outside through the retaining grid into the filter element. The retaining grid can likewise be releasably coupled to the housing section into which the filter element is inserted. The centering arrangement between the retaining grid and the filter element and a guided attachment between the retaining grid and the housing section into which the filter element is inserted make possible an exact positioning of the filter element relative to the housing section.

In an alternative embodiment, the mating part may be an additional functional element, particularly a pre-separator, such that the filter element can be handled via the functional element. In certain applications it is useful to connect a pre-separator, such as a cyclone pre-separator, upstream of the actual filter element. According to the invention, this pre-separator can be releasably coupled to the filter element to allow the filter element to be handled without the risk of damaging the filter medium.

In another alternative, the mating part is constructed as a holding tool for handling the filter element. Feasible, for example, is a T-shaped handle, which can be inserted into the opening of the support member with the single leg of the T and releasably coupled thereto, so that the filter element can be handled via the T-shaped piece. However, any other configuration of holding device allowing accurate handling is also feasible.

If the mating part is constructed as a holding tool, then the mating part is preferably releasably disposed in a housing section. For servicing or repair of the filter element, the handle is thus always available in the immediate vicinity of the filter element and the service person does not need to carry along a tool. The holding tool can be snapped or clipped into a recess in the housing. It is preferably permanently connected to the housing to ensure that it is available at all times. Feasible, for example, is an arrangement similar to a key for the chuck of a drilling machine.

As an alternative, the mating part in the form of a holding tool can be releasably disposed in an additional opening of the support member, such that, to use it, the mating part is pulled out of the support member. Advantageously, the mating part can be locked inside an additional opening of the support member, but it does not protrude axially from the end face plane of the filter element. It can be fastened, for example, by a toggle or a film hinge that is destroyed when the support member is removed. In this manner, the handle member is coupled to the filter element and can be identified at first glance and is available to anyone. It is also possible to release the mating part via some type of coil spring mechanism within the support member and to cause the handle member to become locked with the support member in a certain position as the handle member is pulled out, to enable a direct handling of the filter element. It is likewise possible to initially separate the support member completely from the handle member, in the next step to insert the handle member into the matching openings of the support member and to establish the coupling in this opening.

In the filter assembly according to the invention comprising a filter element and a mating part as described above, the filter element is disposed in a first housing section, such that in the vicinity of the first end face of the filter element, a circumferential radial seal of the filter element is seated against a correspondingly configured housing seat of the first housing section. The first end face of the filter element is the inlet face. The radially circumferential seal seated against the housing seat of the first housing section seals the inlet side from the discharge side, whereby a piece of a second housing section in the form of a fluid-permeable support grid which functions as the above-described mating part is clipped into the opening of the support member of the filter element. The outer contour of the fluid-permeable support grid is configured to correspond with the end face seating surface of the circumferential seal, and fasteners are disposed along the outer contour for releasably attaching the second housing section to the first housing section and clamping the circumferential seal of the filter element between them. This centers the filter element relative to the second housing section, and the second housing section further centers it relative to the first housing section. After the coupling between the two housing sections has been released, the filter element can be handled via the second housing section. For servicing, the second housing section together with the releasably coupled filter element can be placed on a table, for example, and the two parts can then be separated by releasing a clip connection between the second housing section and the filter element. If the filter element is replaced during servicing, the new filter element is then clipped into the second housing section, such that the second housing section and the filter element are centered, and the second housing section and the coupled filter element are then inserted into the first housing section and interconnected via a coupling between the first and second housing sections.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawing figures, in which:

FIG. 1 is a schematic view of a complete filter assembly according to the invention;

FIG. 2 is a schematic view of the retaining grid and the filter element;

FIG. 3 is a schematic view of the retaining grid and the associated support member without the filter medium, and

FIG. 4 is a separate view of the support member.

### DETAILED DESCRIPTION OF PREFERRED EMBODIMENTS

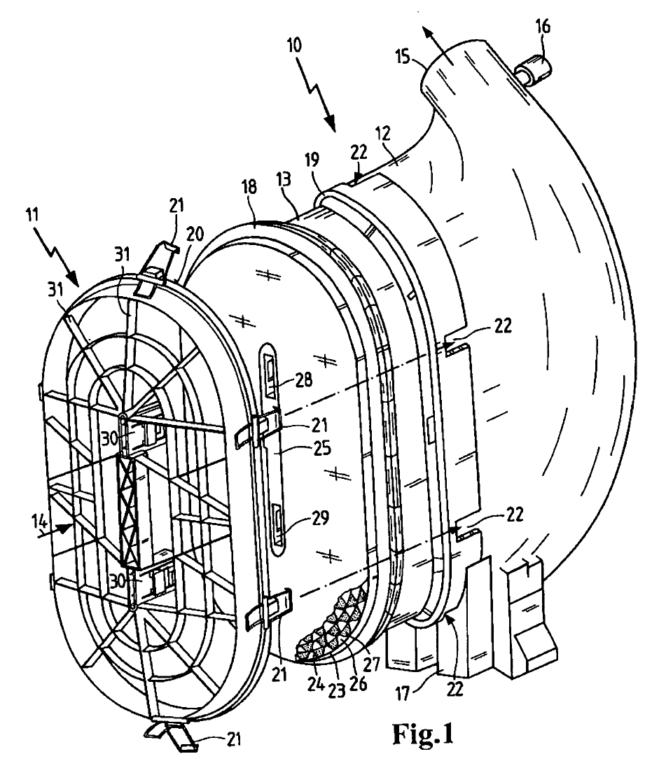

FIG. 1 shows a filter assembly 10 for stationary use to filter the intake air of a compressor. This filter assembly 10 may, however, also be used in mobile applications wherever an air stream needs to be filtered. The filter assembly 10 comprises a first housing section 12 and a second housing section in the form of a retaining grid 11, with a filter element 13 arranged therebetween so as to form a seal. The fluid flows axially through the filter element 13, such that the one end face represents the inlet 14 and the first housing section 12 comprises the discharge or outlet 15. A servicing indicator 16 is disposed in the region of the outlet 15, which indicates by a corresponding representation that the filter element 13 needs to be serviced when the loading of the filter element has reached a corresponding level. The first housing section 12 is connected to a base via a housing flange 17.

To seal an unfiltered side from a filtered side, the filter element 13 has a circumferential seal 18 arranged in the region of the first end face of the filter element 13. The seal 18 is seated against a seal seating surface 19 of the first housing section 12 and thus forms a seal via the filter element 13 between the interior of the housing and the environment. To fix the filter element 13 in the first housing section 12, the retaining grid 11 is pressed against the circumferential seal 18 via a seating surface 20 which is provided on the retaining grid 11 and is then locked into place with snap hooks 21 which are provided on the retaining grid 11 and engage in recesses 22 formed in the first housing section 12.

The filter element 13 is made of alternating flat filter layers 23 and folded filter layers 24, which are wound around a support member 25 disposed in the center of the filter element. When wound around the support member 25, the alternating flat layers 23 and folded layers 24 form a channel structure, which is sealed with an adhesive to form alternating open channels 26 and closed channels 27. Hence the air to be filtered, as it passes through the filter element 13, must first enter one of the open channels 26, then passes through either the flat filter layer 23 or the folded filter layer 24 in the course of the channel and finally exits the filter element 13 through the open outlet end of neighboring channel 27. In other words, each channel 26 that is open on the first end face is sealed at its second end face and the neighboring channels 27 around each channel 26 are conversely sealed at the first end face and open at the other end face.

The support member 25 disposed in the filter element 13 has a first opening 28 and a second opening 29, each of which receives a coupling element 30 connected to the retaining grid 11. The combination of the coupling element 30 and the openings 28, 29 enables the handling of the filter element 13 via the retaining grid 11. The connection between the coupling element 30 and the support member 25 via the openings 28, 29 is releasable. To stabilize the retaining grid 11 and to protect the end face surface of the filter element 13, ribs 31 are formed on the retaining grid 11, which cause only an absolutely minimal pressure loss at the inlet face of the filter element 13 but protect the filter element 13 well against damage. Furthermore, by a toolless engagement with the ribs 31, the filter element 13 can be handled for servicing via the retaining grid 11.

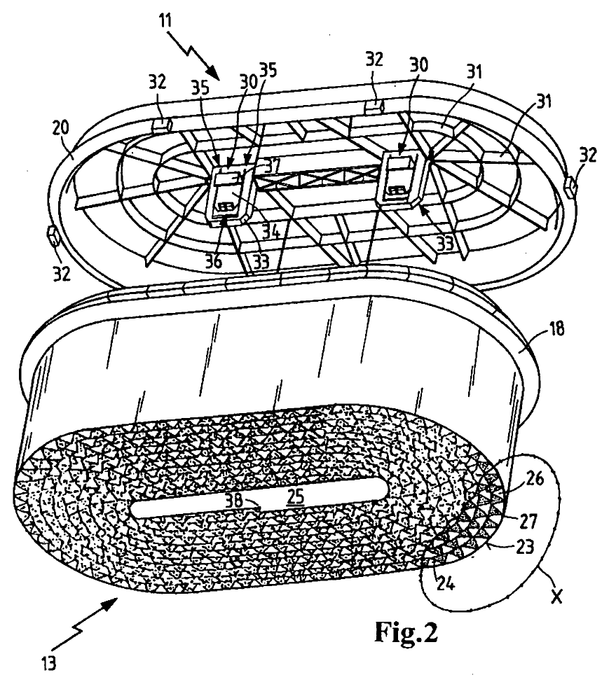

FIG. 2 depicts a schematic view of the retaining grid 11 and the filter element 13. Components corresponding to those shown in the preceding figure are identified by the same reference numerals. A plurality of retaining elements 32 is distributed circumferentially around the collar of the retaining grid 11 at which the snap-in hooks 21 are connected to the retaining grid 11. The figure clearly shows the configuration of the coupling elements 30 on the retaining grid 11. At their distal ends, the coupling elements 30 have insertion guide bevels 33 which ensure a self-centering coupling without skewing between the retaining grid 11 and the filter element 13 when the retaining grid 11 and the filter element 13 are connected. The coupling elements 30 have a box-shaped profile with latching plates 34 arranged on the two large outer surfaces. These latching plates 34 are integrally connected with the coupling elements 30. Because the latching plates 34 are separated from the coupling elements 30 along their longitudinal edges by slots 35 and are furthermore not connected to the coupling elements 30 along their lower side opposite the ribs 31, they are flexible transversely to the direction of the connection between the retaining grid 11 and the filter element 13. Outwardly projecting snap-in hooks 36 are disposed in the lower region of the latching plates 34, and pressure parts 37 are provided in the upper region near the connection with the coupling element 30. The snap-in connection to the support member 25 created by the snap-in hooks 36 can be released from the outside via these pressure parts 37 by reaching through the ribs 31 of the retaining grid 11 and pressing the coupling plates 34 together.

In the lower region of the support member 25, a stop edge 38 may be seen, which extends axially along the entire height of the support member 25 all the way to the upper end face. The first layer of the filter medium to be wound, which consists of a flat layer 23 and a folded layer 24, is positioned to adjoin the stop edge 38 of the support member 25, is fixed in this position by applying adhesive and is wound (clockwise in this embodiment) around the support member. The detail “X” separately shows the open channels and the sealed channels 27 as well as the flat filter layers 23 and the folded filter layers 24 described with reference to FIG. 2.

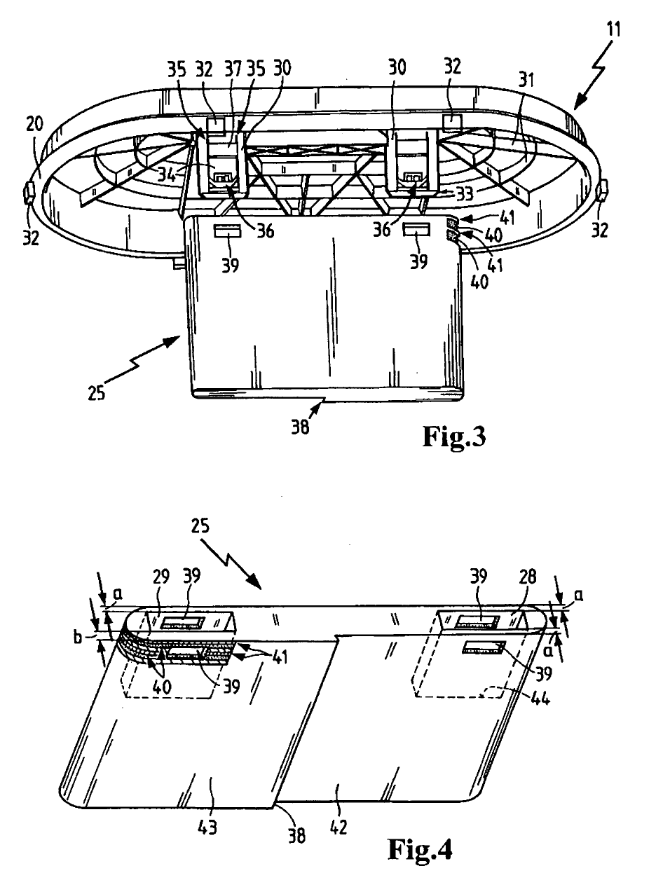

FIG. 3 likewise shows a schematic view of the retaining grid 11 just before it is coupled to the support member 25. Components corresponding to those of the preceding figures are identified by the same reference numerals. To clearly illustrate the connection, the filter medium and the circumferential seal 18 have been omitted in this figure. To create the snap-in connection with the snap-in hooks 36, the support member 25 is provided with four windows 39. These windows may be configured as through-openings or as non-through-going receptacles for the snap-in hooks 36. In the upper right area of the support member, two grooves 40 are arranged in the vicinity of the right window 39, such that the remaining material in the form of strips 41 has the same height as the rest of the support member. This ensures that, when the filter medium is wound onto the support member 25, the wound layers 23, 24 are seated against the support member 25 throughout.

FIG. 4 depicts a separate schematic view of the support member 25. Components corresponding to those shown in the preceding figures are identified by the same reference numerals. The above-described coupling elements 30, the geometric dimensions of which are preferably identical, engage in the openings 28 and 29 of the support member 25. Because the support member 25, as a result of the stop edge 38, has a side 42 where the material is thinner and a side 43 where the material is thicker, and the openings 28 and 29, because of the identically configured coupling elements 30, are likewise identical in size, the wall thickness of the support member 25 differs in the region of the openings 28, 29. Since the openings 28, 29 are furthermore axially parallel to each other the opening 28 has two walls of thickness (a) twice whereas the opening 29 has one wall of thickness (a) and one wall of substantially greater wall thickness (b). The support member is preferably produced using an injection molding process, such that a material accumulation in the production process should be avoided. By forming the two grooves 40, which are arranged only in the region of the greater wall thickness (b), this material accumulation is avoided to prevent warping of the support member 25 or an unnecessary stress build-up in the region of the opening 29. By making the openings 28 and 29 as a type of blind hole, the lower terminating edge of the openings 28, 29 forms an axial stop 44 for the coupling elements 30. This ensures that an axial force applied in the direction of the filter element 13 when the filter element 13 is handled via the retaining grid 11 does not push right through and destroy the retaining grid 11.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A filter element for end face inflow of a fluid stream, said filter element comprising:
at least one flat layer and at least one folded layer of flow-through filter media, wherein the at least one flat layer alternates with the at least one folded layer such that channels with an open cross section are formed, wherein a first group of said channels are tightly sealed at one end and a second group of said channels are tightly sealed at an opposite end such that the fluid to be filtered, as it flows through the filter element from an inlet side which is formed by an end face of the filter element to an outlet side which is formed by the opposite end face of the filter element, must pass through one of said layers which are provided to filter the fluid;
a seal for sealing the inlet side of the filter from the discharge side of the filter element in a housing section, and
at least one support member arranged in the center of the filter element surrounded by said channels, said support member extending axially substantially up to at least one end face of the filter element;
wherein each channel of the first group of channels which is spaced from the periphery of the filter element is surrounded on each side by channels of the second group, so that the fluid to be filtered can flow through the full area of the channels of the first group except for the folded edges of the channels, and
wherein the support member is provided on a surface proximate said at least one axial end face of the filter element with at least one opening for receiving a projecting portion of corresponding mating part so that the filter element may be handled via the mating part.

2. A filter element according to claim 1, wherein said channels have a triangular cross-section.

3. A filter element according to claim 1, wherein the at least one flat layer and the at least one folded layer are wound alternately around the support member, and the support member has a step extending along the axial length of the support member, said step forming a stop edge for a first layer of filter media wound around the support member.

4. A filter element according to claim 3, wherein the support member is oblong in shape; said step is arranged substantially in the center of the oblong support member, and an opening is provided each respective end region of said surface proximate said at least one axial end face of the filter element for receiving a projecting portion of corresponding mating part so that the filter element may be handled via the mating part.

5. A filter element according to claim 4, wherein the support member has at least one groove which is arranged parallel to the end face on the outer surface in the vicinity of at least one opening.

6. A filter element according to claim 1, wherein an axial stop for the mating part is arranged in at least one opening of the support member.

7. A mating part for a filter element according to claim 1, wherein said mating part comprises at least one projecting portion configured to correspond to the at least one opening in the support member such that the mating part can be releasably coupled to the support member in the interior of the opening.

8. A mating part according to claim 7, wherein said at least one projecting portion is divided into a guiding and centering part and a coupling part.

9. A mating part according to claim 7, wherein the mating part is a housing section, whereby the filter element can be handled via the housing section.

10. A mating part according to claim 9, wherein said housing section comprises a retaining grid.

11. A mating part according to claim 7, wherein the mating part is an additional functional element, whereby the filter element can be handled via said additional functional element.

12. A mating part according to claim 11, wherein said additional functional element is a cyclone pre-separator.

13. A mating part according to claim 7, wherein the mating part is a holding tool for handling the filter element.

14. A mating part according to claim 13, wherein the mating part is releasably arranged in a housing section.

15. A mating part according to claim 13, wherein the mating part is releasably arranged in an additional opening of the support member, whereby the mating part is pulled out of the support member for use.

16. A filter assembly comprising a filter element and a mating part according to claim 7, wherein the filter element is disposed in a first housing section; a radially circumferential seal of the filter element in the region of the first end face of the filter element is seated against a correspondingly configured housing seat of the first housing section such that a seal is created between the inlet side and the discharge side of the filter element; the mating part is a second housing section having at least one projecting portion clipped into the at least one opening of the support member of the filter element; said second housing section comprising a fluid-permeable retaining grid having an outer contour configured to correspond to the end face seating surface of the circumferential seal, and latching members are arranged on the outer contour of the second housing section for releasably attaching the second housing section to the first housing section with the circumferential seal of the filter element clamped therebetween, wherein upon release of the housing sections from each other, the filter element can be handled via the second housing section.
